(19) United States
(12) Patent Application Publication
(10) Pub. No.: US 2025/0123355 A1
(43) Pub. Date: Apr. 17, 2025

(54) WAVEGUIDE ANTENNA AND RADAR SYSTEM

(71) Applicant: Mitsubishi Electric Corporation, Tokyo (JP)

(72) Inventors: Yosuke TSUZAKI, Tokyo (JP); Takashi OHARA, Tokyo (JP); Eri KUWAHARA, Tokyo (JP); Masahiro KAWAI, Tokyo (JP)

(73) Assignee: Mitsubishi Electric Corporation, Tokyo (JP)

(21) Appl. No.: 18/809,765

(22) Filed: Aug. 20, 2024

(30) Foreign Application Priority Data
Oct. 13, 2023 (JP) 2023-177187

(51) Int. Cl. G01S 7/03; H01Q 13/02; H01Q 13/10

(52) U.S. Cl. CPC G01S 7/03; H01Q 13/02; H01Q 13/10

(57) ABSTRACT

A radar system is provided with a waveguide antenna that includes a stacked body of metal plates in which a plurality of punched holes is provided, and a waveguide that is formed in an inner side in the stacking direction. A transverse portion of the waveguide extending in a direction perpendicular to the stacking direction is formed by a space in which the plurality of punched holes of the metal plates adjacent to each other among the punched holes is connected in the stacking direction, and in a portion corresponding to an outside of a bend portion at which a direction of the transverse portion is changed to the stacking direction, a recess is formed to suppress a change in a cross-sectional area perpendicular to a direction of travel of the radio wave by shifting an outer peripheral position of the punched holes that are connected.

### TECHNICAL FIELD

The present disclosure relates to a waveguide antenna and a radar system.

### BACKGROUND ART

In recent years, an advanced driver-assistance system (ADAS) that detects information on the surrounding environment of an automobile by using various sensors and provides an assistance to a driver for safe and comfortable driving has been adopted in many automobiles. Examples of such functions include autonomous emergency braking (AEB) for detecting an obstacle and automatically stopping the vehicle, and adaptive cruise control (ACC) for accelerating and decelerating while a vehicle traveling ahead is followed. In addition, there is a blind spot monitor (BSM) or the like that detects another vehicle approaching from the rear and notifies the driver of the other vehicle at the time of lane change or the like.

In order to implement such functions, it is necessary to detect another vehicle or the like from a far distance, and a camera, a radar, or the like is used as a sensor. The ADAS has been evolved more and more, and performance required for the radar, such as a detection distance of a detection target and separation performance when multiple targets are present, has been improved. In addition, in order to implement these functions, it is required to monitor not only the front of the vehicle but also the side of the front, the side of the rear, and the rear of the vehicle. Therefore, the radar is mounted depending on a monitoring area, and the number of radars mounted in one automobile increases. As a result, the radar and the antenna are increasingly required to have higher performance, a lower cost, and a smaller size.

On the other hand, in the conventional millimeter-wave radar, a microstrip line antenna has been used from the viewpoint of cost reduction and miniaturization. However, in the microstrip line antenna, a feeder line from a transmitter/receiver for feeding power to the antenna must be wired in a plane, and the feeder line cannot cross wires or other antennas. For this reason, since the wire is long or a space for the wiring is required to exceed the size of the antenna, the line loss increases, performance is deteriorated, and it is not suitable for the miniaturization.

Therefore, a radar employing a waveguide antenna with a low loss and suitable for miniaturization has emerged. In the waveguide antenna, a radio wave is distributed to each antenna by a waveguide made of, for example, a hollow conductor, and since the waveguide can three dimensionally intersect, the degree of freedom of wiring connected to the antenna is increased, and the antenna can be connected at the shortest distance.

In order to implement such a radar at low cost, a waveguide antenna formed of a resin to which conductivity is imparted (for example, refer to Patent Document 1) and a waveguide antenna formed by stacking metal plates (for example, refer to Patent Document 2) have been proposed.

### PRIOR ART DOCUMENT

### Patent Document

Patent Document 1: Japanese Patent Application Laid-Open (Translation of PCT Application) No. 2021-515186 (paragraphs 0021 to 0026, FIG. 4) Patent Document 2: WO2009/119225 (paragraphs 0016 to 0017, FIG. 1 to FIG. 5)

### SUMMARY OF INVENTION

### Problems to be Solved by Invention

However, a monolithic microwave integrated circuit (MMIC) that transmits and receives radio waves of a radar generates a large amount of heat, and thus it is necessary to actively dissipate heat in order to secure required performance. In addition, due to the evolution of the ADAS, sensing data processing is advanced, and processors such as a microcomputer and a field programmable gate array (FPGA) are also heat generation sources.

In this regard, since the waveguide antenna made of resin must be arranged near a substrate, the heat radiation of the electronic component such as the MMIC is hindered, and thus it is necessary to additionally install a heat radiation mechanism, which is a factor hindering the reduction in cost and size, as a whole. On the other hand, when a waveguide antenna is formed by stacking metal plates having excellent thermal conductivity, the transmitting and receiving efficiency may be reduced even if the temperature rise of the MMIC is suppressed.

The present disclosure discloses a technique for solving the above-described problems, and an object of the present disclosure is to provide a low-cost, compact, high-performance radar system.

### Means for Solving Problems

A waveguide antenna disclosed in the present disclosure includes a stacked body that has a plate shape and is made of metal plates in which a plurality of punched holes that is patterned is provided, a plurality of apertures that is formed on one face to couple radio waves with a plurality of respective ports of a high-frequency device having the plurality of ports for performing at least one of transmission and reception of the radio waves, a plurality of antennas that is formed on the other face to couple the radio waves with an outside, and a waveguide that is formed in an inner side in the stacking direction to communicate between the plurality of apertures and the plurality of respective antennas. A transverse portion of the waveguide extending in a direction perpendicular to the stacking direction is formed by a space in which the plurality of punched holes of the metal plates adjacent to each other among the punched holes is connected in the stacking direction, and in a portion corresponding to an outside of a bend portion at which a direction of the transverse portion is changed to the stacking direction, a recess is formed to suppress a change in a cross-sectional area perpendicular to a direction of travel of the radio waves by shifting an outer peripheral position of the punched holes that are connected.

The waveguide antenna disclosed in the present disclosure includes the stacked body that has a plate shape and is made of the metal plates in which the plurality of punched holes that is patterned is provided, the plurality of apertures that is formed on one face to couple the radio waves with the plurality of respective ports of the high-frequency device having the plurality of ports for performing at least one of transmission and reception of the radio waves, the plurality of antennas that is formed on the other face to couple the radio waves with an outside, and the waveguide that is formed in an inner side in the stacking direction to communicate between the plurality of apertures and the plurality of respective antennas. A fin to dissipate heat generated by the high-frequency device is formed on a side of the waveguide antenna by changing an outer shape of each layer of the metal plates or by a cutout provided in an outer periphery in the metal plates.

### Advantageous Effect of Invention

According to the waveguide antenna and the radar system of the present disclosure, it is possible to obtain a low-cost, compact, high-performance radar system by suppressing impedance mismatch or excessive heat generation.

### BRIEF DESCRIPTION OF THE DRAWINGS

FIG. 1 is an end view showing a configuration of a radar system according to Embodiment 1.

FIG. 2A and FIG. 2B are a plan view showing a surface facing the MMIC and a plan view showing an antenna surface in a waveguide antenna constituting the radar system according to Embodiment 1, respectively.

FIG. 3 is a schematic diagram showing a dimensional configuration of the waveguide formed in the waveguide antenna constituting the radar system according to Embodiment 1.

FIG. 4A and FIG. 4B are a schematic diagram showing a shape of a bent portion of the waveguide formed in the waveguide antenna constituting the radar system according to Embodiment 1 and an enlarged end view of the bent portion of the waveguide, respectively.

FIG. 5 is an end view showing a configuration of a radar system according to a variation example of Embodiment 1;

FIG. 6 is an end view showing a configuration of a radar system according to Embodiment 2.

FIG. 7 is an end view showing a configuration of a radar system according to Embodiment 3.

FIG. 8A and FIG. 8B are a plan view showing a surface facing an MMIC and a plan view showing an antenna surface, in a waveguide antenna constituting a radar system according to a variation example of Embodiment 3, respectively.

FIG. 9 is an end view showing a configuration of a radar system according to Embodiment 4.

FIG. 10A and FIG. 10B are a plan view showing an outer shape of a first metal plate and a plan view showing an outer shape of a second metal plate, respectively, among metal plates of a waveguide antenna constituting a radar system according to Embodiment 5.

FIG. 11 is a partial perspective view showing a shape of an end portion of a waveguide antenna constituting the radar system according to Embodiment 5.

### MODE FOR CARRYING OUT INVENTION

### Embodiment 1

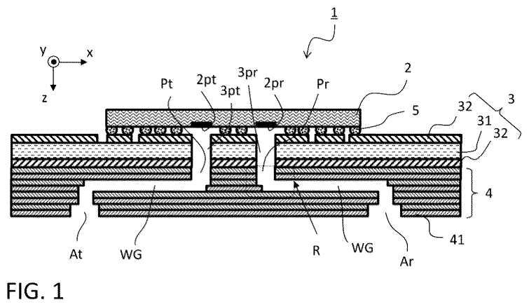

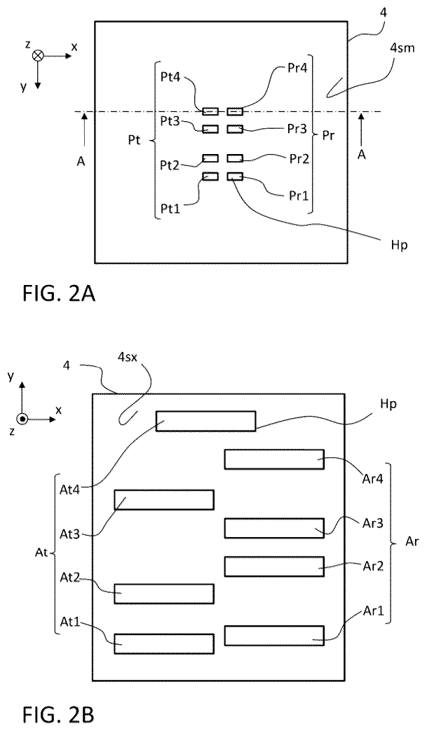

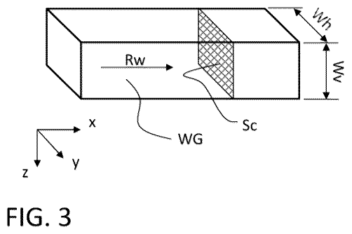

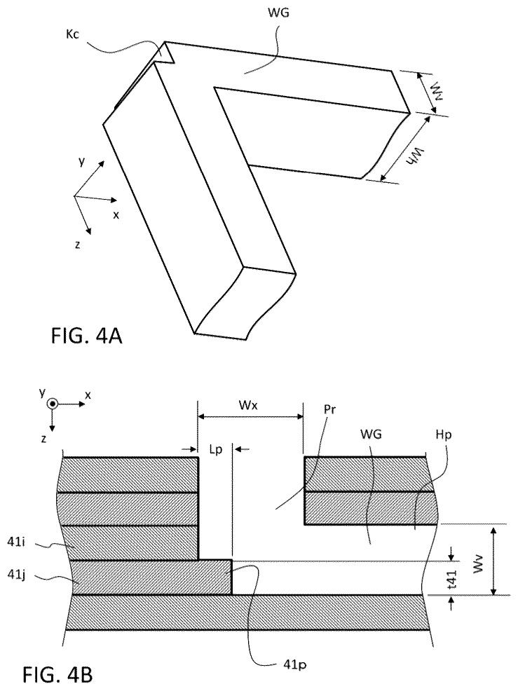

FIG. 1 to FIG. 5 are diagrams for describing configurations of a waveguide antenna and a radar system according to Embodiment 1 and a variation example, FIG. 1 is an end view showing a configuration of the radar system taken along a line A-A in FIG. 2A to be described later, FIG. 2A is a plan view showing a surface of the waveguide antenna facing an MMIC, and FIG. 2B is a plan view showing an antenna surface of the waveguide antenna. FIG. 3 is a schematic view showing a dimensional configuration of the waveguide formed in the waveguide antenna, FIG. 4A is a schematic view showing a shape of a bent portion of the waveguide constituted and formed in the waveguide antenna, and FIG. 4B is an enlarged end view of the bent portion of the waveguide corresponding to a region R in FIG. 1.

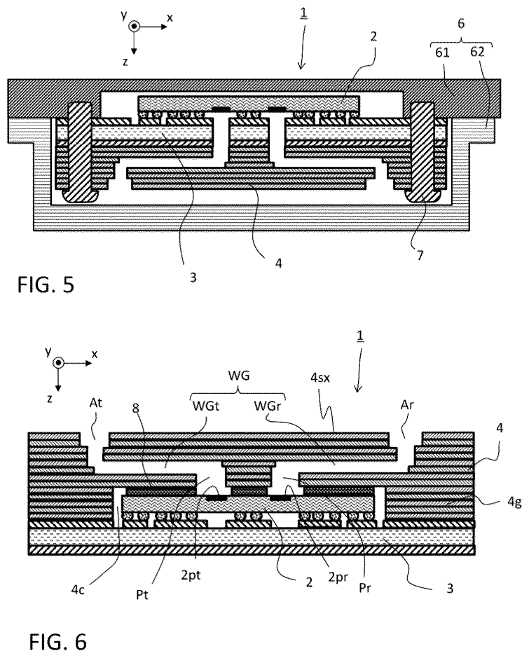

FIG. 5 is an end view corresponding to FIG. 1, showing a configuration of a waveguide antenna and a radar system according to a variation example. Note that, in the present disclosure, a main surface of each of the waveguide antenna, a substrate, and the MMIC is parallel to an x-y plane, and a thickness direction (stacking direction) is a z-direction. In addition, in the present disclosure, for convenience of drawing, an aperture range of the antenna in the end view is drawn to be narrower than the dimension analogous to that in the plan view.

As shown in FIG. 1, a radar system 1 of the present disclosure is configured by stacking an MMIC 2, which is a high-frequency device for transmitting and receiving radio waves of a radar, a substrate 3 on which a drive circuit of the MMIC 2 is formed, and a plate-shaped waveguide antenna 4 for coupling a radio wave from the MMIC 2 in a layered manner.

An in-vehicle radar (radar system 1) detects a detection target by transmitting a radio wave from an antenna (waveguide antenna 4) and receiving reflected waves from the detection target. As the radio waves, a 24 GHz band, a 77 GHz band, a 81 GHz band, and the like (wavelengths λ=12.7 mm, 3.9 mm, 12.5 mm) for the radio waves called millimeter waves are used as transmission frequency bands.

In the in-vehicle radar, a plurality of transmitting antennas (At) and a plurality of receiving antennas (Ar) are used, and azimuth information can be acquired in addition to distance information of a detection target on the basis of the signal processing of these.

The waveguide antenna 4 is a stacked body in which thin metal plates 41 each provided with a plurality of punched holes Hp that is patterned are stacked in the thickness direction (z-direction), and is a thick plate in which a waveguide WG is formed inside thereof. On a surface (antenna surface 4sx) on which the antennas are arranged as shown in FIG. 2B, transmitting antennas At1 to At4 and receiving antennas Ar1 to Ar4 are arranged. As the transmitting antenna At and the receiving antenna Ar, array antennas are used in many cases, and it is possible to increase the gain and adjust the directivity. Here, the antenna may be a type of a slot antenna, a horn antenna, or the like. In the present disclosure, as an example, the radar system 1 in which the transmitting antenna At has 4 channels (At1 to At4) and the receiving antenna Ar has 4 channels (Ar1 to Ar4) will be shown.

On the other hand, as shown in FIG. 2A, apertures Pt1 to Pt4 and apertures Pr1 to Pr4 corresponding to the transmitting antennas At1 to At4 and the receiving antennas Ar1 to Ar4, respectively, are formed on a facing surface 4sm facing the MMIC 2 (via the substrate 3). The aperture Pt and the aperture Pr are connected to the transmitting antenna At and the receiving antenna Ar via waveguides WG formed therein, respectively. Therefore, the radio waves can be transmitted and received by connecting the apertures Pt and Pr to ports 2pt and 2pr of the MMIC 2, respectively.

The MMIC 2 is mounted, for example, via solder balls 5 on the substrate 3, which is a high-frequency substrate and also referred to here as an RF (Radio Frequency) substrate. In the substrate 3, a circuit pattern 32 is arranged on both surfaces of an insulating base material 31, and a bore 3pt and a bore 3pr penetrating in the thickness-wise direction are formed in correspondence with the port 2pt for transmitting the radio waves and the port 2pr for receiving the radio waves that are formed on the surfaces of the MMIC 2 package in accordance with the number of channels.

The waveguide antenna 4 is arranged so as to be close to or in contact with a face opposite to the mounting surface of the substrate 3 to which the MMIC 2 is attached. In the substrate 3, the above-described bores 3pt and 3pr are arranged in regions sandwiched between the ports 2pt and 2pr of the MMIC 2 and the apertures Pt and Pr of the waveguide antenna 4.

The bores 3pt and 3pr must be provided in an area that overlaps at least the ports 2pt and 2pr of the MMIC 2 and the apertures Pt and Pr of the waveguide antenna 4 when the substrate 3 is viewed from a distance along a direction perpendicular to its main surface (thickness-wise direction: z-direction). This means that each of the transmitting antenna At and receiving antenna Ar of the waveguide antenna 4 will be connected to the ports 2pt and 2pr formed in the MMIC 2 for each channel via the bores 3pt and 3pr formed in the substrate 3.

Here, before describing the characteristic part of the radar system 1 of the present disclosure, issues in the radar system will be described. Note that, in the description as a typical radar system, components similar to those of the radar system 1 of the present disclosure will be also described without reference numerals and signs.

The MMIC is an integrated and packaged semiconductor device for radar processing, such as generating, transmitting, and receiving radio waves. Recently, a micro-computer for radar signal processing has also been integrated in some cases, and the functionality has been improving. On the other hand, there is a portion in the chip of the MMIC where heat is highly generated, leading to reduced radar detection performance and reduced reliability due to reduced output and increased noise, and thus efficient heat dissipation must be achieved to obtain a radar with good detection performance. Therefore, conventionally, additional heat-dissipating components, such as a heat sink on the backside of an electronic substrate, have been required for cooling the MMIC.

In contrast, the waveguide antenna formed by stacking metal plates has high thermal conductivity and thus has high heat dissipation efficiency, and can act itself as a heat sink as described below. In addition, since the waveguide antenna is easy to broaden the bandwidth, there are advantages of higher resolution of detection distance and ease of bandwidth change to avoid interference when a plurality of antennas is mounted on a vehicle.

Further, as described in the background art, the waveguide antenna can be wired three-dimensionally for feeding lines, so that the desired antenna arrangement and feeding to the antenna can be done with a minimum projected area. In addition, since there is no coupling or unwanted radiation between the waveguides WG, leading to highly resistant to noise and improvement on the signal-to-noise ratio.

Here, the material used to construct the waveguide antenna must be conductive. Specifically, it can be made using metal, conductive resin, or non-conductive material such as resin that is given conductivity by surface plating or other means. And since the waveguide antenna is a hollow structure, it will be divided into several parts and made part by part, and then pasted together to form a single unit. As in Patent Document 1, it has also been proposed to construct a waveguide antenna by forming a metal layer on the surface of resin, but it has a problem in terms of the heat dissipation.

For example, the resin, as a material, has a thermal conductivity of about 0.1 to 0.2 W/m·K, and for example, considering that the thermal conductivity of metal aluminum is 200 W/m·K or more, it is less than 1/100th and quite small. Furthermore, the thermal conductivity of the air that fills the hollow portion formed inside the antenna is about 0.03 W/m·K, making the antenna thermally insulated. Therefore, the waveguide antenna made of resin cannot efficiently dissipate heat from the MMIC, causing the temperature of the MMIC to rise, and thus a characteristic depending on the temperature and output limitation etc. occur, thereby leading to reduced radar performance, increased cost for additional heat dissipation mechanisms, and increased size in the product.

Since the waveguide antenna is manufactured by pasting divided parts together without gaps, a practical problem is that when the antenna is manufactured with resin, warping creates gaps, so the warping is adjusted by lightening to prevent warping. Even in that case, when the parts are pasted together, a cavity is created inside the waveguide antenna due to the lightened portions, making the antenna even more thermally insulated. Therefore, when resin is adopted, the heat dissipation problem is likely to be apparent.

In contrast, the waveguide antenna 4 of the present disclosure is composed of the metal plates 41 stacked as disclosed in Patent Document 2, which eliminates the above-mentioned heat conduction problem. Moreover, by stacking press punched aluminum or copper plate materials with good thermal conductivity, it can be manufactured at low cost.

However, the waveguide antenna composed of the stacked metal plates often suffers from reduced transmitting and receiving efficiency due to impedance mismatch. By finding out that a phenomenon described above occurs, the radar system 1 of the present disclosure is devised to overcome the problem.

Basically, a cross-sectional shape Sc perpendicular to the direction of travel of a radio wave Rw of the waveguide WG should be rectangle as shown in FIG. 3, and can be easily achieved by stacking punched metal plates. When the cross-sectional shape Sc has a longitudinal dimension Wh and a transverse dimension Wv, the longitudinal dimension Wh must be λ/2 or longer if the wavelength of a propagating electromagnetic wave is λ. If it is less than λ/2, the radio wave will not propagate.

Therefore, the longitudinal dimensions Wh for 24 GHz, 77 GHz, and 81 GHz need to be at least 6.25 mm, 1.95 mm, and 1.85 mm, respectively. Here, it is desirable to make the longitudinal dimension Wh as small as possible in order to make the antenna smaller. However, if the longitudinal dimension Wh is set at the lower limit, i.e., exactly λ/2, the radio wave passing characteristics will be steep depending on variations in the manufacturing, and thus considering a margin, the dimension should be set to 1.2 to 1.3 times λ/2.

The general standard for waveguides states 8.636 mm×4.318 mm (EIA standard, WR-34) for the 24 GHz band and 2.540 mm×1.270 mm (EIA standard, WR-10) for the 77 to 81 GHz band, and the longitudinal dimension Wh is often sized according to the above. On the other hand, the transverse dimension Wv should be set to about half the height of the above (2.16 mm for the 24 GHz band and 0.635 mm for the 77 to 81 GHz band), since there is no restriction by the wavelength as described above.

The thickness and the number of layers of the metal plates 41 to implement such a waveguide WG are set depending on which of the longitudinal dimension Wh and the transverse dimension Wv is applied to the thickness (in the z-direction) and the width (in the x-y plane) (whether it is a tall vertical rectangle or a long horizontal rectangle). The basic idea is that when the waveguide is made by stacking plates, it is a premise that the number of plates (number of layers) should be as small as possible from a cost perspective.

Therefore, it has been common practice to form a waveguide using the space enclosed by the punched holes Hp in a single metal plate by matching the thickness of the metal plate to the width (height) of the transverse portion of the waveguide in the stacking direction, as in, for example, Patent Document 2. However, when such a waveguide is used, impedance mismatch sometimes occurs, resulting in poor performance. Therefore, a detailed examination of the structure of such a waveguide shows that when a waveguide is bent from the transverse direction to the thickness direction, for example, a bend by 90 degrees as shown in FIG. 4A, the cross-sectional shape of the waveguide is to be changed. The capacitance will change accordingly, resulting in a change in impedance relative to that in the straight waveguide.

The impedance change differs between an E-plane bend (bend in the plane parallel to the transverse dimension Wv) as shown in FIG. 4A and a H-plane bend (bend in the plane parallel to the longitudinal dimension Wh), but in both cases, a simple bend causes impedance mismatch and reflection. It was found out that the reflection deteriorates the transmitting and receiving efficiency in the antenna, and also adversely affects the connected transmitter and receiver because of the energy return during transmission.

Therefore, in the radar system 1 of the present disclosure, among the metal plates 41 constituting the waveguide antenna 4, the metal plates 41 having a thickness t41 equal to or less than ½ the transverse dimension Wv of the waveguide WG is used at least for the portion forming the waveguide WG, as shown in FIG. 4b. In other words, the waveguide WG portion is composed of a series of the punched holes Hp of two or more metal plates 41 adjacent to each other in the stacking direction. Then, for example, a protrusion 41p is formed in the waveguide WG by shifting the position of the outer periphery of the punched hole Hp of a metal plate 41j along the advancing direction by Lp (=t41) to the inner side relative to the metal plate 41i, with respect to the E-plane bend that is from the stacking direction (z-direction) to the plane perpendicular to the stacking direction (x-y). This protrusion 41p causes to form a recess Kc in the outer corner of the bend of the waveguide WG to compensate for the capacitance change.

In other words, positions of the outer periphery of the punched holes Hp of a plurality of the metal plates 41 that constitute the portion of the waveguide WG in which the radio wave Rw travels in the transverse direction (parallel to the x-y plane) is changed from layer to layer along the direction of travel of the radio wave Rw. This creates the recess Kc in the bend portion by forming in the outer portion of the bend, the protrusion 41p protruding toward the waveguide WG, thereby suppressing the occurrence of impedance mismatch with a minimum number of the plates.

Of course, if three or more metal plates 41 are used and each of aperture positions thereof is shifted, the cross-sectional change is even smoother than when two metal plates 41 are used, and compensation for capacitance change can be made with higher precision. However, for manufacturing point of view, it is desirable for the fewer number of layers and types of punching patterns (molds), and thus it is desirable to use two layers (metal plates 41i and 41j), as in the present disclosure.

Instead of shifting the outer peripheral position of the punched hole Hp and forming the stepped recess Kc in the bend as described above, it is also possible to form the periphery of the punched hole Hp to be slanted, so that the bend portion is formed to be provided with a chamfer. However, since formation of the slant requires more processes than the simple punching process and it is more difficult to maintain surface accuracy, the structure in which the peripheral position of the punched hole Hp of an adjacent metal plate is shifted is preferable in terms of the cost.

The metal plate 41 described above can be made by press-forming of a sheet metal, and especially metal with good thermal conductivity should be used. For example, by using aluminum, a lightweight waveguide antenna 4 with good heat dissipation can be achieved. Or, by using copper, a waveguide antenna 4 with better heat dissipation can be achieved.

The suitable method for fixing the stacked metal plates 41 is to integrate them by diffusion bonding. If the waveguide antenna 4 is regarded as a single metal body, the presence of discontinuous surfaces such as split surfaces inside the metal body causes a decrease in thermal conductivity there. In the diffusion bonding of the metal, the bonding surfaces are pressurized and heated to adhere to each other, and thus they are bonded and integrated by the diffusion phenomenon of metal atoms. After the diffusion bonding, the surfaces are integrated without any interface, so that the thermal conductivity does not decrease, and thus it is a suitable method.

However, the fixing method is not limited to the diffusion bonding. For example, even if the metal plate 41 is bonded or fixed by other means, thermal conduction as a metal body deteriorates, but it is still sufficiently large compared to the case formed using resin. Therefore, even if the metal plate 41 is fixed using welding or an adhesive, the effect of the heat dissipation can be obtained. Note that, when using an adhesive, for example, a thermal conductive adhesive using a filler with excellent thermal conductivity may be used.

### Variation Example

FIG. 5 is an end view corresponding to FIG. 1, showing a configuration of a waveguide antenna and a radar system according to a variation example. For example, the radar system 1 is used while housed within a radar housing 6 (base plate 61 and dome part 62) as shown in FIG. 5. In such a case, even if the metal plates 41 are not in the case where they are bonded or adhered to each other as described above, the waveguide antenna 4 is integrated to be a metal body with excellent heat conduction by providing the metal plates 41 with through holes as part of the punched holes Hp and fixing them to the base plate 61 with screws 7 while they are stacked.

Thus, the waveguide antenna 4 that can suppress the impedance mismatch is placed in the vicinity of the MMIC 2 so as to be in thermal contact with the antenna, whereby the antenna can also be used as a heat sink. Note that the case of the thermal contact here refers to a state in which the thermal conductivity when the heat generated by the MMIC 2 is dissipated is greater than that of air. With this arrangement, the heat can be easily conducted from the package of the MMIC 2 to each of the metal plates 41 constituting the waveguide antenna 4, thereby enhancing the heat dissipation.

In FIG. 1 and FIG. 5, the waveguide antenna 4 is drawn such that the face formed with the apertures Pt and Pr (facing surface 4sm) is in contact with the entire surface of the substrate 3, but the entire surface does not necessarily need to be in contact therewith. Partial contact or proximity can also be used to obtain the thermal contact.

Regarding an area where the substrate 3 and the waveguide antenna 4 are in thermal contact, by forming the circuit pattern 32 in a shape in accordance with the contact area, the thermal conduction at the contact area can be improved. In addition, by connecting the circuit pattern 32 of the substrate 3 on the side of the MMIC 2 to the circuit pattern 32 on the side of the waveguide antenna 4 with vias that are not shown, it is possible to efficiently transfer heat from the MMIC 2 to the waveguide antenna 4.

Furthermore, in FIG. 1 and FIG. 5, a state is drawn such that the waveguide antenna 4 is formed with the metal plates 41 of the same thickness, but this is not a limitation. The metal plate corresponding to at least the portion for the height of the waveguide WG that runs in the x-y plane has the thickness t41 with which two or more sheets are required, but for other portions, the metal plates 41 having a different thickness may be used as long as the metal having a thickness is easy to be punched out. For example, the plate on the upper side of the metal plate 41i in FIG. 4b may be made of a single metal plate 41.

### Embodiment 2

In Embodiment 1, a configuration in which the substrate is interposed between the MMIC and the waveguide antenna has been described. In Embodiment 2, a configuration in which a waveguide antenna is arranged on the face opposite to the face connected to the substrate of the MMIC is described. FIG. 6 is an end view corresponding to FIG. 1, showing a configuration of the waveguide antenna and a radar system according to Embodiment 2. Note that, except for the positional relationship between the substrate, the MMIC, and the waveguide antenna, the configuration is the same as that of Embodiment 1, and the description of the similar portions is omitted and FIG. 2A to FIG. 4B used in Embodiment 1 will be referred to.

The radar system 1 according to Embodiment 2 is an application example using a type of MMIC 2 that transmits and receives radio waves from the ports 2pt and 2pr arranged on the top (negative side in the z-direction) of the package, as shown in FIG. 6. In this case, the waveguide antenna 4 must be arranged on the same side of the substrate 3 as the side on which the MMIC 2 is arranged.

Therefore, the waveguide antenna 4 has a leg portion 4g to form a space 4c that houses the MMIC 2. The apertures Pt and Pr are located within the space 4c to couple the radio waves from the ports 2pt and 2pr provided on the top surface of the MMIC.

In the present embodiment, the waveguide antenna 4 is in contact with the surface on the substrate 3 on which the MMIC 2 is mounted, or in close proximity to the surface (distance less than two metal plates 41 away), which means to be thermal contact. In this example, the heat generated by the MMIC 2 is conducted to the waveguide antenna 4 via the substrate 3 or directly.

According to this arrangement example, the top of the MMIC 2, and the area in close proximity other than the apertures Pt and Pr of the waveguide antenna 4 can be coated with thermal conductive grease 8 or the like to improve the heat dissipation. In the area where the leg portion 4g of the waveguide antenna 4 makes contact with the substrate 3, the heat dissipation can be further improved by forming the circuit pattern 32 corresponding to the contact area.

### Embodiment 3

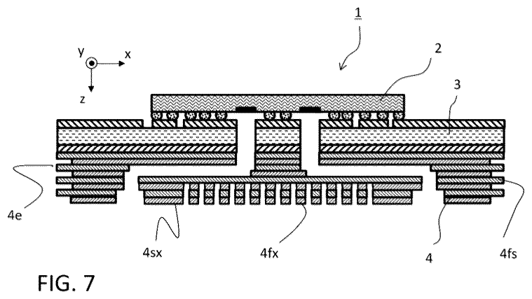

In Embodiment 1 and Embodiment 2 described above, the shape of the heat-dissipating portion of the waveguide antenna has not been described. In Embodiment 3 and following embodiments, the configuration in which the heat-dissipating portion is formed in the form of fins will be described. FIG. 7 illustrates a configuration of a waveguide antenna and a radar system in Embodiment 3, and is an end view corresponding to FIG. 1 in Embodiment 1. The configuration other than the heat-dissipating portion of the waveguide antenna is the same as in Embodiment 1 or Embodiment 2, and the description of the similar portions is omitted and FIG. 2A to FIG. 4B used in Embodiment 1 will be referred to.

In the waveguide antenna 4 and the radar system 1 according to Embodiment 3, as illustrated in FIG. 7, an outer dimension (the length in the x-direction in the figure, the length in the y-direction although not illustrated, or the lengths in both directions) of an adjacent metal plate 41 of the waveguide antenna 4 is periodically changed along the stacking direction. For example, the outer dimensions of the metal plates 41 to be stacked are alternately changed for each layer to form unevenness on the side, and heat generated in the MMIC 2 is dissipated to the space via the waveguide antenna 4. In this case, since the surface area is increased by providing the unevenness on the waveguide antenna, it is possible to improve the heat conduction to the air.

That is, since the unevenness on the lateral side is the heat dissipation fins 4fs, the heat radiation efficiency can be improved. In particular, when each metal plate is thin and the number of metal plates that are stacked is large, the number of unevenness formed in the peripheral portion is increased, and thus the heat radiation performance can be further improved. On the other hand, when it is preferable to widen the interval between the fins from the viewpoint of the flow path resistance formed between the fins, for example, the outer dimensions may be changed every two fins or every three fins.

Further, in order to form the unevenness on the portion of the antenna surface 4sx of the waveguide antenna 4, by punching out a part of the surface (in the formation of the punched holes Hp) when forming each of the metal plates 41, for example, grooves (fins 4fx) can be formed when the metal plates 41 are stacked with each other although there is no penetration in the y-direction. According to this configuration, the fins 4fx for heat dissipation can be easily formed also on the antenna surface 4sx, and the heat dissipation performance is further improved.

### Variation Example

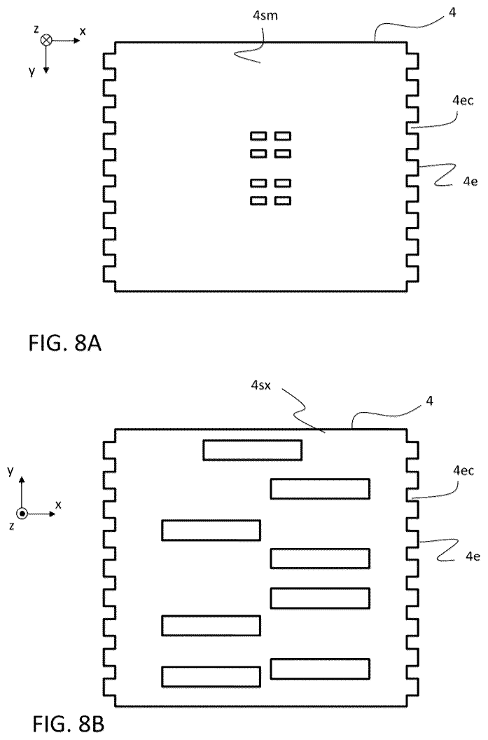

FIG. 8A is a plan view corresponding to FIG. 2A of Embodiment 1, showing a surface of the waveguide antenna facing the MMIC according to a variation example, and FIG. 8B is a plan view corresponding to FIG. 2B of Embodiment 1, showing an antenna surface of the waveguide antenna. As shown in FIG. 8A and FIG. 8B, cutouts 4ec are intermittently formed at the same period in a side end portion 4e of each of the metal plates 41. Thus, fins extending along the stacking direction (thickness direction: z-direction) may be formed on the side faces of the waveguide antenna 4. This configuration allows economical manufacturing by reducing the need for additional processes to form the fins.

### Embodiment 4

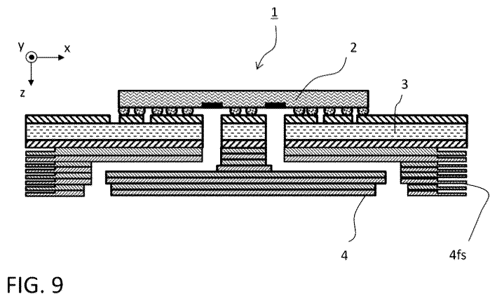

In Embodiment 3, an example has been described in which the fins extending along the direction parallel to the surface of the metal plate is formed on the side faces by alternately increasing and decreasing the outer dimension along the stacking direction. In Embodiment 4, an example will be described in which fins extending along the direction parallel to the surface of the metal plate is formed on the side faces by making the thickness of the end portion of each metal plate thinner than the other portion. FIG. 9 is an end view corresponding to FIG. 1, showing a configuration of a waveguide antenna and a radar system according to Embodiment 4. Note that the configuration of the waveguide antenna other than the fins is the same as in Embodiment 1 to Embodiment 3, and the description of the same portions will be omitted, and FIG. 2A to FIG. 4B used in Embodiment 1 will be referred to.

In the waveguide antenna 4 and the radar system 1 according to Embodiment 4, as shown in FIG. 9, by thinning side end portions of each metal plate 41, it is possible to form the fins 4fs with a finer pitch than in the case described in FIG. 7. This structure can be formed by rolling and thinning the end portions at the same time when each metal plate 41 is formed by press punching. When the end portions are to be thinned in forming cutouts in the waveguide WG, it can be formed easily because there is a margin for the plate to extend, for example, unlike a case where the outer periphery of the punched hole Hp, which is to be inside in the plane of the metal plate 41, is to be slanted. This configuration also allows economical manufacturing by reducing the need for additional processes.

### Embodiment 5

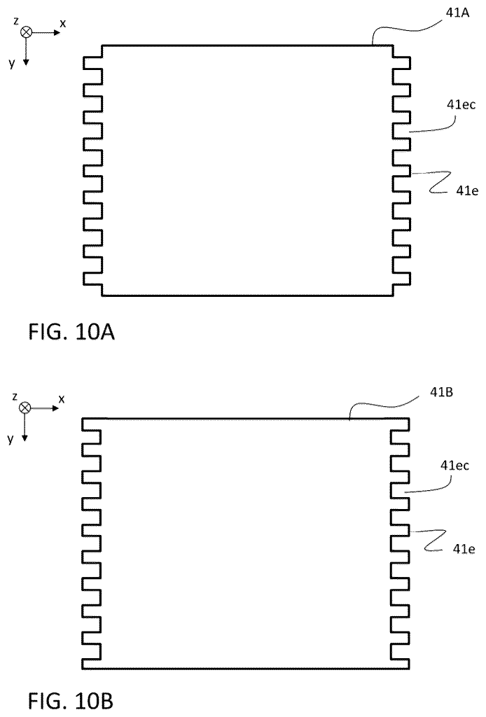

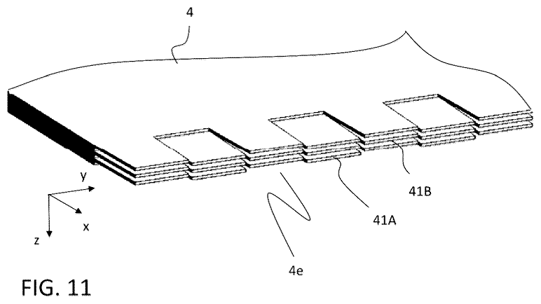

In Embodiment 3 and Embodiment 4, an example in which the fins extending in a certain direction is formed on the side faces of the waveguide antenna has been described. In Embodiment 5, an example in which fins intermittently arranged along a certain direction are arranged in a staggered manner will be described. FIG. 10A, FIG. 10B, and FIG. 11 are for describing a configuration of a waveguide antenna and a radar system according to Embodiment 5, FIG. 10A is a plan view showing the outer shape of a first metal plate among the metal plates of the waveguide antenna, FIG. 10B is a plan view showing the outer shape of a second metal plate, and FIG. 11 is a partial perspective view showing the arrangement of the fins formed on a side face of the waveguide antenna when the first metal plate of FIG. 10A and the second metal plate of FIG. 10B are alternately stacked.

Note that, in FIG. 10A and FIG. 10B, only the outer shape of the metal plate is drawn, and the drawing of the punched holes is omitted. In addition, configurations other than the fins of the waveguide antenna are the same as those of Embodiment 1 to Embodiment 4, and the description of the same portions will be omitted, and FIG. 2A to FIG. 4B used in Embodiment 1 will be referred to.

As shown in FIG. 10A and FIG. 10B, in the waveguide antenna 4 and the radar system 1 according to Embodiment 5, two kinds of metal plates 41 constituting the waveguide antenna 4, the first metal plate 41A and the second metal plate 41B based on their outer shapes, are to be formed. In each of the first metal plate 41A and the second metal plate 41B, the cutouts 41ec are periodically and intermittently arranged in a side end portion 41e, but the positions of the cutouts 41ec are to be shifted from each other.

Accordingly, as shown in FIG. 11, the metal plates 41 to be the first metal plate 41A and the second metal plate 41B are alternately stacked such that the cutouts 41ec and the protruding portions of the metal plates adjacent to each other in the stacking direction are alternately arranged in the stacking direction. That is, the fins are formed on the side faces of the waveguide antenna 4 by each of the first metal plate 41A and the second metal plate 41B, and thus the fins are to be arranged in a staggered manner. According to the present configuration, even the fins having a complicated shape for improving the heat dissipation can be formed at a low cost by the press punching.

Note that, although various exemplary embodiments and examples are described in the present disclosure, various features, aspects, and functions described in one or more embodiments are not inherent in an application of the contents disclosed in a particular embodiment, and can be applicable alone or in their various combinations to each embodiment. Accordingly, countless variations that are not illustrated are envisaged within the scope of the art disclosed in this specification. For example, the case where at least one component is modified, added or omitted, and the case where at least one component is extracted and combined with a component disclosed in another embodiment are included.

For example, in the embodiments described in Embodiment 3 to Embodiment 5, the thicknesses t41 are set to be equal to or less than ½ of the transverse dimension Wv in order to form the recess Kc for suppressing the occurrence of the impedance mismatch, but this is not a limitation. Even when the thickness of the metal plate 41 is larger than ½ of the transverse dimension Wv, at least an efficient heat dissipation effect can be exhibited.

As described above, the waveguide antenna 4 according to the present disclosure includes the stacked body that has a plate shape and is made of metal plates 41 in which the plurality of punched holes Hp that is patterned is provided, the plurality of apertures Pt, Pr that is formed on one face (facing surface 4sm) to couple the radio waves Rw with the plurality of respective ports 2Pt, 2Pr of the high-frequency device (MMIC 2) having the plurality of ports 2pt, 2pr for performing at least one of transmission and reception of the radio waves Rw, the plurality of antennas (transmitting antenna At, receiving antenna Ar) that is formed on the other face (antenna surface 4sx) to couple the radio waves Rw with an outside, and the waveguide WG that is formed in an inner side in the stacking direction to communicate between the plurality of apertures Pt, Pr and the plurality of respective antennas (transmitting antenna At, receiving antenna Ar). The transverse portion of the waveguide WG extending in a direction perpendicular to the stacking direction (parallel to x-y plane) is formed by a space in which the plurality of punched holes of the metal plates 41 adjacent to each other among the punched holes Hp is connected in the stacking direction (z-direction), and in the portion corresponding to an outside of the bend portion at which a direction of the transverse portion is changed to the stacking direction (z-direction), the recess Kc is formed to suppress a change in the cross-sectional area (area of cross-sectional shape Sc) perpendicular to a direction of travel of the radio waves Rw by shifting the outer peripheral position of the punched holes Hp that are connected. Therefore, the occurrence of the impedance mismatch can be suppressed, so that a low-cost, compact, high-performance radar system 1 can be obtained.

Further, when the fin (heat dissipation fin 4fs) is formed in a side portion (the side end portion 4e) to dissipate heat generated by the high-frequency device (MMIC 2), the temperature rise in the MMIC 2 is suppressed and operation stability is improved.

Further, another waveguide antenna 4 according to the present disclosure includes the stacked body that has a plate shape and is made of the metal plates 41 in which the plurality of punched holes Hp that is patterned is provided, the plurality of apertures Pt, Pr that is formed on one face (facing surface 4sm) to couple the radio waves RW with the plurality of respective ports 2pt, 2pr of the high-frequency device (MMIC 2) having the plurality of ports 2pt, 2pr for performing at least one of transmission and reception of the radio waves Rw, the plurality of antennas (transmitting antenna At, receiving antenna Ar) that is formed on the other face (antenna surface 4sx) to couple the radio waves Rw with an outside, and the waveguide WG that is formed in an inner side in the stacking direction (z-direction) to communicate between the plurality of apertures Pt, Pr and the plurality of respective antennas (transmitting antenna At, receiving antenna Ar). The fin (heat dissipation fin 4fs) to dissipate heat generated by the high-frequency device is formed in a side portion (the side end portion 4e) of the waveguide antenna 4 by changing an outer shape of each layer of the metal plates 41 or by the cutout 4ec provided in the outer periphery in the metal plates 41. Therefore, the heat generated by the MMIC 2 is effectively dissipated, thereby preventing the MMIC 2 from overheating and improving its operational stability, and thus a low-cost, compact, high-performance radar system 1 can be obtained.

In addition, when the face (antenna surface 4sx) on which the plurality of antennas (transmitting antenna At, receiving antenna Ar) is formed has a fin 4fx formed by connecting the plurality of punched holes Hp, temperature rise at the MMIC 2 is suppressed, so that its operational stability is improved.

Furthermore, the radar system 1 according to the present disclosure includes the waveguide antenna 4, the high-frequency device (MMIC 2) described above, and the substrate 3 on which a drive circuit for driving the high-frequency device is formed and on the mounting surface of which the high-frequency device is mounted. Since the waveguide antenna 4 is arranged on the face opposite to the mounting surface of the substrate 3, and the through holes (bores 3pt and 3pr) are formed in the substrate 3 at the positions corresponding to the plurality of apertures Pt, Pr and the plurality of ports 2pt, 2pr, using the MMIC 2 whose ports 2pt, 2pr arranged to direct downward, a low-cost, compact, high-performance radar system 1 can be obtained.

Alternatively, the radar system includes the waveguide antenna 4 described above, the high-frequency device (MMIC 2) described above, and the substrate 3 on which a drive circuit for driving the high-frequency device is formed and on the mounting surface of which the high-frequency device is mounted. When the plurality of ports 2pt, 2pr is arranged on the face of the high-frequency device (MMIC 2) opposite to the face facing the substrate 3, and the waveguide antenna 4 is arranged on the mounting surface of the substrate 3 so as to straddle the high-frequency device, using the MMIC 2 whose ports 2pt, 2pr arranged to direct upward, a low-cost, compact, high-performance radar system 1 can be obtained.

What is claimed is:

1. A waveguide antenna comprising:
a stacked body that has a plate shape and is made of metal plates in which a plurality of punched holes that is patterned is provided;
a plurality of apertures that is formed on one face to couple radio waves with a plurality of respective ports of a high-frequency device having the plurality of ports for performing at least one of transmission and reception of the radio waves;
a plurality of antennas that is formed on the other face to couple the radio waves with an outside; and
a waveguide that is formed in an inner side in the stacking direction to communicate between the plurality of apertures and the plurality of respective antennas, wherein
a transverse portion of the waveguide extending in a direction perpendicular to the stacking direction is formed by a space in which the plurality of punched holes of the metal plates adjacent to each other among the punched holes is connected in the stacking direction, and
in a portion corresponding to an outside of a bend portion at which a direction of the transverse portion is changed to the stacking direction, a recess is formed to suppress a change in a cross-sectional area perpendicular to a direction of travel of the radio waves by shifting an outer peripheral position of the punched holes that are connected.

2. The waveguide antenna according to claim 1, wherein a fin is formed in a side portion thereof to dissipate heat generated by the high-frequency device.

3. A waveguide antenna comprising:
a stacked body that has a plate shape and is made of metal plates in which a plurality of punched holes that is patterned is provided;
a plurality of apertures that is formed on one face to couple radio waves with a plurality of respective ports of a high-frequency device having the plurality of ports for performing at least one of transmission and reception of the radio waves;
a plurality of antennas that is formed on the other face to couple the radio waves with an outside; and
a waveguide that is formed in an inner side in the stacking direction to communicate between the plurality of apertures and the plurality of respective antennas, wherein
a fin to dissipate heat generated by the high-frequency device is formed in a side portion of the waveguide antenna by changing an outer shape of each layer of the metal plates or by a cutout provided in an outer periphery in the metal plates.

4. The waveguide antenna according to claim 2, wherein a face on which the plurality of antennas is formed has a fin formed by connecting the plurality of punched holes.

5. The waveguide antenna according to claim 3, wherein a face on which the plurality of antennas is formed has a fin formed by connecting the plurality of punched holes.

6. A radar system comprising:
the waveguide antenna according to of claim 1;
the high-frequency device; and
a substrate on which a drive circuit for driving the high-frequency device is formed and on a mounting surface of which the high-frequency device is mounted, wherein
the waveguide antenna is arranged on a face opposite to the mounting surface of the substrate, and through holes are formed in the substrate at positions corresponding to the plurality of apertures and the plurality of ports.

7. A radar system comprising:
the waveguide antenna according to of claim 2;
the high-frequency device; and
a substrate on which a drive circuit for driving the high-frequency device is formed and on a mounting surface of which the high-frequency device is mounted, wherein
the waveguide antenna is arranged on a face opposite to the mounting surface of the substrate, and through holes are formed in the substrate at positions corresponding to the plurality of apertures and the plurality of ports.

8. A radar system comprising:
the waveguide antenna according to of claim 3;
the high-frequency device; and
a substrate on which a drive circuit for driving the high-frequency device is formed and on a mounting surface of which the high-frequency device is mounted, wherein
the waveguide antenna is arranged on a face opposite to the mounting surface of the substrate, and through holes are formed in the substrate at positions corresponding to the plurality of apertures and the plurality of ports.

9. A radar system comprising:
the waveguide antenna according to claim 4;
the high-frequency device; and
a substrate on which a drive circuit for driving the high-frequency device is formed and on a mounting surface of which the high-frequency device is mounted, wherein
the waveguide antenna is arranged on a face opposite to the mounting surface of the substrate, and through holes are formed in the substrate at positions corresponding to the plurality of apertures and the plurality of ports.

10. A radar system comprising:
the waveguide antenna according to claim 5;
the high-frequency device; and
a substrate on which a drive circuit for driving the high-frequency device is formed and on a mounting surface of which the high-frequency device is mounted, wherein
the waveguide antenna is arranged on a face opposite to the mounting surface of the substrate, and through holes are formed in the substrate at positions corresponding to the plurality of apertures and the plurality of ports.

11. A radar system comprising:
the waveguide antenna according to claim 1;
the high-frequency device; and
a substrate on which a drive circuit for driving the high-frequency device is formed and on a mounting surface of which the high-frequency device is mounted, wherein
the plurality of ports is arranged on a face of the high-frequency device opposite to a face facing the substrate, and
the waveguide antenna is arranged on the mounting surface of the substrate so as to straddle the high-frequency device.

12. A radar system comprising:
the waveguide antenna according to claim 2;
the high-frequency device; and
a substrate on which a drive circuit for driving the high-frequency device is formed and on a mounting surface of which the high-frequency device is mounted, wherein
the plurality of ports is arranged on a face of the high-frequency device opposite to a face facing the substrate, and
the waveguide antenna is arranged on the mounting surface of the substrate so as to straddle the high-frequency device.

13. A radar system comprising:
the waveguide antenna according to claim 3;
the high-frequency device; and
a substrate on which a drive circuit for driving the high-frequency device is formed and on a mounting surface of which the high-frequency device is mounted, wherein
the plurality of ports is arranged on a face of the high-frequency device opposite to a face facing the substrate, and
the waveguide antenna is arranged on the mounting surface of the substrate so as to straddle the high-frequency device.

14. A radar system comprising:
the waveguide antenna according to claim 4;
the high-frequency device; and
a substrate on which a drive circuit for driving the high-frequency device is formed and on a mounting surface of which the high-frequency device is mounted, wherein
the plurality of ports is arranged on a face of the high-frequency device opposite to a face facing the substrate, and
the waveguide antenna is arranged on the mounting surface of the substrate so as to straddle the high-frequency device.

15. A radar system comprising:
the waveguide antenna according to claim 5;
the high-frequency device; and
a substrate on which a drive circuit for driving the high-frequency device is formed and on a mounting surface of which the high-frequency device is mounted, wherein
the plurality of ports is arranged on a face of the high-frequency device opposite to a face facing the substrate, and
the waveguide antenna is arranged on the mounting surface of the substrate so as to straddle the high-frequency device.
